(19) United States
(12) Patent Application Publication
(10) Pub. No.: US 2004/0267985 A1
(43) Pub. Date: Dec. 30, 2004

(54) Information processor, method therefor, program therefor, recording medium storing the program and reproducing device

(76) Inventors: Yukio Numakami, Tokorozawa-shi (JP); Kenichiro Tada, Tokorozawa-shi (JP); Takashi Aoki, Tokorozawa-shi (JP); Ken Miyagawa, Tokorozawa-shi (JP); Kyotaro Sato, Tokorozawa-shi (JP); Hiroshi Nakamura, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/855,883

(22) Filed: May 28, 2004

(30) Foreign Application Priority Data
May 29, 2003 (JP) 2003-152072

(51) Int. Cl. G06F 13/38

(52) U.S. Cl. 710/68

(57) ABSTRACT

A data is acquired from a network connector (110) and sequentially stored in a data receiving buffer (120). A communication line monitor (141) detects a transfer rate (vr) of acquiring the data at a communication line. A reproduction speed controller (142) reads a receiving buffer volume (Br). When the volume (Br) is equal to or less than a predetermined thresbold (Bu), the reproduction speed controller (142) sets a reproduction rate (v₀) so that the data is reproduced at a reproduction speed slower than a standard reproduction speed at which an output unit reproduces the data. The reproduction speed (v₀) decreases as the receiving buffer volume (Br) decreases. The data is output to a processor (130) at the reproduction rate (v₀). The processor (130) extracts a stream data and decodes it to output as a reproduction data to an output unit for reproduction.

### BACKGROUND OF THE INVENTION

1. Field of the Invention

The present invention relates to an information processor for controlling information output, a method therefor, a program therefor, a recording medium storing the program, and a reproducing device.

2. Description of Related Art

A known conventional art for controlling information output is for example, a reproducing method that sequentially stores received compressed data and sequentially reproduces it (Refer to, for example, Japanese Patent Laid-Open Publication No. 2003-8680, the left column on page 4 to the right column on page 7).

According to this publication, a compressed data is received by an antenna and sequentially held in a receiving buffer. When the receiving buffer holds the compressed data of a predetermined length, the compressed data is decoded by a decoder and reproduced from a speaker.

In such art, however, unless a buffer volume exceeds a predetermined volume, the reproduction is stopped. For example, in a condition that the compressed data is acquired over a network, if the communication speed decreases due to traffic increase on the network and the volume of the data held in the receiving buffer becomes less than the volume of data for reproduction, the decoding is stopped or a buffer underflow occurs in the receiving buffer and thus the reproduction is stopped.

### SUMMARY OF THE INVENTION

An object of the present invention is to provide an information processor for continuously outputting information, a method therefor, a program therefor, a recording medium storing the program, and a reproducing device.

An information processor according to an aspect of the present invention incudes: an information acquiring unit that acquires information; storage that temporarily stores the information acquired by the information acquiring unit and sequentially outputs the information in the order of storing the information; a processor that sequentially processes the information stored in the storage in an outputable manner; and a control unit that controls the processor to sequentially process the information stored in the storage in the outputable manner, and controls the processor to process the information stored in the storage so that the information is output at a speed slower than a standard speed at which an output unit outputs the information when the volume of the information stored in the storage is equal to or less than a predetermined volume.

An information processing method for acquiring information to sequentially process the information in an outputable manner according to another aspect of the present invention includes the steps of: acquiring information; temporarily storing the acquired information; and sequentially processing the information in the order of storing the information so that the information is output at a speed slower than a standard speed for outputting the information when the volume of the stored information is equal to or less than a predetermined volume.

An information processing program according to still another aspect of the present invention executes the above-mentioned information processing method by an arithmetic unit.

A recording medium according to further aspect of the present invention stores the above-mentioned information processing program in a manner readable by an arithmetic unit.

A reproducing device according to further another aspect of the present invention includes: the above-mentioned information processor according to the present invention; and the output unit for outputting information processed by the information processor.

### BRIEF DESCRIPTION OF THE DRAWINGS

FIG. 1 is a block diagram schematically showing a configuration of an information processor of a reproducing device according to a first embodiment of the present invention;

FIG. 2 is a graph showing control state of a control unit based on relationship between a transfer Rate of receiving data and a receiving buffer volume in the first embodiment, in which (a) is a waveform chart showing the transfer rate, (b) is a waveform chart showing a reproduction rate, (c) is a waveform cart showing the receiving buffer volume, and (d) is a waveform chart showing a decoding buffer volume;

FIG. 3 is a flowchart showing reproduction operation in the first embodiment;

FIG. 4 is a flowchart showing a processing operation to determine the reproduction rate for reproduction operation in the first embodiment;

FIG. 5 is a flowchart showing a reproduction operation of a reproducing device according to a second embodiment of the present invention; and

FIG. 6 is a graph showing control state of a control unit base on relationship between a transfer rate of receiving data and a receiving buffer volume in the second embodiment, in which (a) is a waveform chart showing the transfer rate, (b) is a waveform chart showing a reproduction rate, (c) is a waveform cart showing the receiving buffer volume, and (d) is a waveform chart showing a decoding buffer volume.

### DETAILED DESCRIPTION OF PREFERRED EMBODIMENT(S)

Embodiments according to the present invention will be described below with reference to attached drawings. Although the description of information output in the embodiments is based on a reproducing device by which information is acquired, for example, over a network and output, the information may be acquired and output by any method.

[First Embodiment]

(Configuration of Reproducing Device)

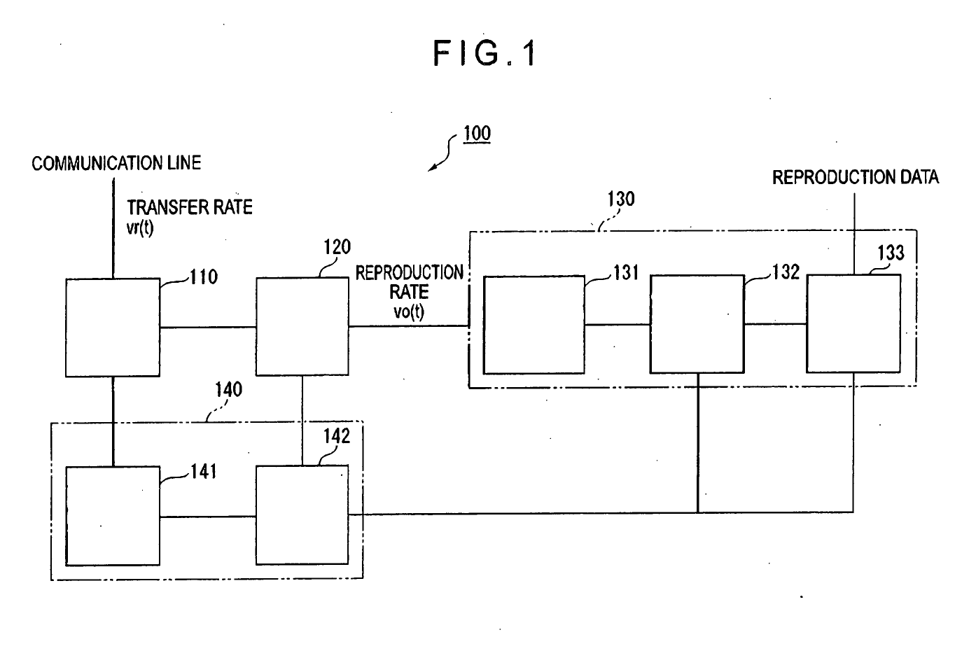

A configuration of a reproducing device for reproducing data will be described with reference to the attached drawings. FIG. 1 is a block diagram schematically showing a configuration of an information processor of the reproducing device.

The reproducing device reproduces a data such as a steam picture data and a stream audio data, which is information acquired, for example, over a network (not shown), as a picture by a display unit (not shown) such as a display device connected to the reproducing device, or as a sound by an audio unit (not shown) having a speaker or the like connected to the reproducing device. The reproducing device includes an input unit not shown), an output unit (not shown), an information processor 100 and the like.

The input unit has a plurality of switches such as buttons and knobs with which a user can perform input operation. The input unit, which is connected to the information processor 100, generates an operation signal in response to the input operation of the switches and outputs the generated operation signal to the information processor 100.

The output unit, which is connected to the information processor 100, acquires reproduction data output from the information processor 100 and outputs it. More specifically, when the display unit such as the display device is used as the output unit as mentioned above, the reproduction data is reproduced as a picture. When the audio unit having a speaker or the like is used as the output unit, the reproduction data is reproduced as a sound.

The information processor 100, which is connected to a network, processes data acquired from the network and generates reproduction data to be reproduced by the output unit. The information processor 100, as shown in FIG. 1, includes a network connector 110 serving as an information acquiring unit, a data receiving buffer 120 serving as a storage, a processor 130, an input unit (not shown), a control unit 140 and the like.

The network connector 110, which is connected to, for example, the network (not shown), acquires data from a communication line constituting the network. For instance, the network connector 110 acquires data with network packet structure over the network from a server connected to the network and storing picture data and audio data in a distributable manner. The network may be the Internet that is operated based on general purpose protocols such as TCP/IP, an intranet, a LAN (Local Area Network), a network such as a communication network and a broadcasting network formed by a plurality of base stations that can exchange information by way of wireless medium, or a radio medium itself that directly sends and receives data. The applicable radio medium may be any of electric waves, light beams, sound waves and electromagnetic waves.

The data receiving buffer 120, which is connected to the network connector 110, sequentially stores the data acquired by the network connector 110 temporarily, and sequentially outputs the data in the order of storing the data.

The processor 130, which is connected to the data receiving buffer 120, sequentially processes the data sequentially output from the data receiving buffer 120 for reproducing it. The processor 130 includes a stream data extractor 131, a decoding buffer 132, a decoder 133 and the like.

The stream data extractor 131, which is connected to the data receiving buffer 120, extracts a series of contiguous stream data such as a stream picture data and a stream audio data out of the data with network packet structure sequentially output from the data receiving buffer 120. The decoding buffer 132, which is connected to the stream data extractor 131, sequentially stores the extracted stream data temporarily, and sequentially outputs the data in the order of storing it. The decoder 133, which is connected to the decoding buffer 132, decodes or decompresses the stream data sequentially output from the decoding buffer 132 at every predetermined timing, and outputs it as a reproduction data. For example, the decoder 133 outputs a picture data to the display unit (the display device, etc.) as the output unit to reproduce it as a picture, or outputs an audio data to the audio unit having the speaker or the like as the output unit to reproduce it as a sound.

The control unit 140 determines whether a receiving buffer volume, which is a data volume stored in the data receiving buffer 120, is equal to or less than a predetermined volume or not, and controls the processor 130 to process the data at a speed slower than a standard speed for reproducing the data when the volume is equal to or less than the predetermined volume. Further, in response to the operation signal from the input unit, the control unit 140 operates the network connector 110 to acquire the data or performs various setting operations including settings/changes of a data processing state of the processor 130 and settings/changes of a sound reproduction state and a picture reproduction state. The control unit 140 has a communication line monitor 141 and a reproduction speed controller 142 and the like.

The communication line monitor 141, which is connected to the network connector 110, detects a communication speed of the data sent over the network, that is, constantly monitors a transfer rate vr(t) of a network packet data received by the network connector 110, and outputs it to the reproduction speed controller 142. In this monitoring, details of which will be described later, the transfer rate vr(t) is measured every minimum unit of time based on, for example, a standard pulse etc.

The reproduction speed controller 142, which is connected to the communication line monitor 141 and the data receiving buffer 120, controls the processor 130 to process the data based on the transfer rate vr(t) output from the communication line monitor 141. Specifically, based on the transfer rate vr(t) from the communication line monitor 141 and the receiving buffer volume that is the data volume stored in the data receiving buffer 120, the reproduction speed controller 142 sets a reproduction rate v₀(t) that is a data reproduction speed, changes a reproduction rate of the data receiving buffer 120 and the decoding buffer 132 and changes a decoding timing of the decoder 133, i.e., changes a reproduction speed.

More specifically, when the receiving buffer volume in the data receiving buffer 120 is larger than a predetermined threshold representing the predetermined volume, a normal decoding at a speed equal to the standard speed for reproducing the data is performed. In contrast, when the receiving buffer volume is less than the predetermined threshold, a decoding is performed at a speed slower than the standard reproduction speed, i.e., at a speed for reproducing the data slower. The threshold is set so that the speed slower than the standard reproduction speed decreases, for example, step-by-step as the receiving buffer volume decreases. The threshold may be changed by, for example, the input operation of the input unit.

(Detailed Structure of Controller)

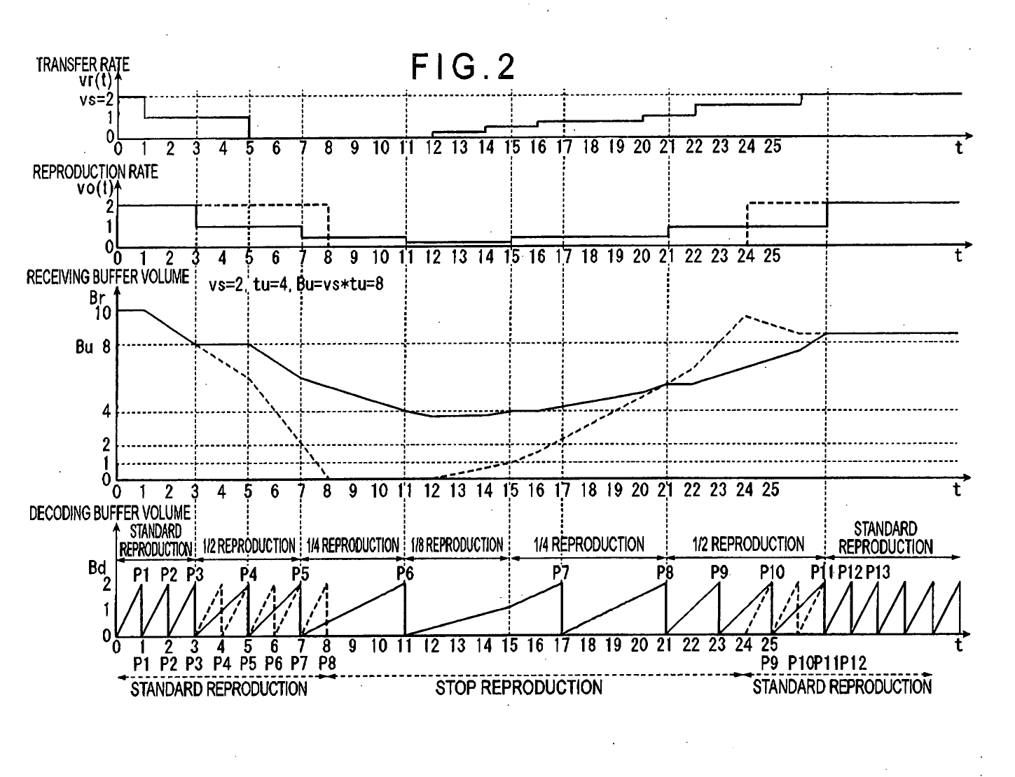

Next, the structure for controlling the processing state of the processor 130 in the control unit 140 will be described with reference to the attached drawings. FIG. 2 is a graph showing control state of the control unit based on relationship between a transfer rate of receiving data and a receiving buffer volume, in which (a) is a waveform chart showing the transfer rate, (b) is a waveform chart showing a reproduction rate, (c) is a waveform cart showing the receiving buffer volume, and (d) is a waveform chart showing a decoding buffer volume. In (d), P1, P2, . . . represent the order of, for example, reproducing a picture data.

The control unit 140, as described above, controls the processing state of the processor 130 based on variation in the receiving buffer volume of the transferred data Specifically, as shown in FIG. 2 the control unit 140 controls the processor 130 to process the data so that the reproduction speed for reproducing the data varies depending on the variation in the receiving buffer volume.

Here, a rate as an original standard reproduction speed for reproducing the stream data such as the stream picture data and the stream audio data is denoted by vs [bps] which is constant irrespective of time, a transfer rate of the data of the network packet received over the communication line of the network is denoted by vr(t) [bps], a receiving buffer volume is denoted by Br [bit], a threshold as a standard for varying the data reproduction speed is denoted by Bu[bit], a reproduction rate for transferring the data from the data receiving buffer 120 to the processor 130 is denoted by v₀(t) [bps], and the decoding buffer volume is denoted by Bd [bit]. The receiving buffer volume Br is a buffer volume that varies with time based on the relationship vr(t)−v₀(t), and v₀(t) is nearly equal to vs when the data is reproduced at the standard reproduction speed. Although v₀(t) is not exactly equal to vs since the stream data consists of the data with network packet structure received over the communication line of which header and the like are removed, they are considered to be equal for convenience of explanation in this embodiment. However, upon actual implementation, the header and the like are taken into consideration.

As shown in FIG. 2, a plurality of thresholds Bu are set, and the control unit 140 controls the processor 130 to process the data so that the reproduction speed of the reproduction data decreases based on each threshold Bu. The thresholds Bu are set based on, for example, Bu=vs*tu. The time tu [second] may be set in any manner, but preferably a power-of-two. The timing for changing the reproduction rate is every minimum unit of time based on, for example, the standard pulse. For convenience of explanation, the unit of time represents 1 second.

Based on the relationship between the receiving buffer volume Br and the transfer rate vr(t) of the data sent with the network packet structure, the condition that the control unit 140 reduces the reproduction speed of the reproduction data relative to the standard reproduction speed is set as follows. When Bu≧Br>Bu/2 at a certain time t1 for example, if a transfer rate vr(t1)≧vs/2, then v₀(t1+1) =vs/2 (½ reproduction speed), otherwise v₀(t1+1)=vs/2²=vs/4 (¼ reproduction speed). When Bu/2≧Br>Bu/4 at a certain time t2 for example, if a transfer rate vr(t2)≧vs/4, then v₀(t2+1)=vs/4 (1/4 reproduction speed), otherwise v₀(t2+1)=vs/2³ vs/8 (⅛ reproduction speed). Similarly, when Bu/4≧Br>Bu/8 at a certain time t3 for example, if a transfer rate vr(t3)≧vs/8, then v₀(t3+1)=vs/8 (⅛ reproduction speed), otherwise v₀(t3+1)=vs/2⁴ =vs/16 (1/16 reproduction speed). Conditions for the reproduction speed are set by repeating the above in the same way. These conditions are represented by a conditional expression in below Expression 1.

[Expression 1]

For some i ∈ Z₀ (natural number)

Bu/2ⁱ≧Br>Bu/2ⁱ⁺¹, and

If vr(t)≧vs/2ⁱ⁺¹ then v₀(t+1)=vs/2ⁱ⁺¹

Else v₀(t+1)=vs/2ⁱ⁺²

For example, when the transfer rate vr(t) varies as shown in FIG. 2(a) and the receiving buffer volume becomes less than the predetermined threshold Bu as shown in FIG. 2(c), the control unit 140 controls the processor 130 to make the reproduction rate slower than the standard reproduction speed (e.g. v₀(t)=2) as shown in FIG. 2(b). That is, the control unit 140 controls the decoder 133 to reduce its decoding speed. in response to this control, the decoding buffer volume Bd varies as shown in FIG. 2(d). In FIG. 2, the transfer rate vr(t) is 2 Mbps and the receiving buffer volume Br is 10 Mbit, however, these figures are only an example may be subjected to change.

More specifically, when t=2 and the transfer rate vr(2) decreases to half (1 Mbps) as shown in FIG. 2(a), the reproduction rate v₀(1) is v₀=2 Mbps and hence the receiving buffer volume Br decreases step-by-step as shown in FIG. 2(c). Then, when t=3, Br=8≦Bu=8. When t=3, since the transfer rate vr(3)=1≧vs/2=1 and hence v₀(3+1)=vs/2=1 as show in FIG. 2(b), the control unit 140 controls the processor 130 to reduce the reproduction speed to ½ reproduction speed as shown in FIG. 2(c). That stops the decrease of the receiving buffer volume Br as shown in FIG. 2(c).

When t=6 and the transfer rate vr(6) becomes zero, the reproduction rate v₀(6) is already 1 [Mbps] and hence the receiving buffer volume Br decreases step-by-step again as shown in FIG. 2(c). Then, when t=7, Bu=8≧Br=6>Bu/2=4. When t=7, since the transfer rate vr(7)=0<vs/2=1 and hence v₀(7+1)=vs/4=0.5 as show in FIG. 2(b), the control unit 140 controls the processor 130 to reduce the reproduction speed to ¼ reproduction speed as shown in FIG. 2(c). That inhibits the decrease of the receiving buffer volume Br as shown in FIG. 2(c).

When t=11, the transfer rate vr(11) remains zero and hence Br=4≦Bu/2=4. When t=11, since the transfer rate vr(11)=0<vs/4 and hence v₀(11+1)=vs/8=0.25 as show in FIG. 2(b), the control unit 140 controls the processor 130 to reduce the reproduction speed to ⅛ reproduction speed as shown in FIG. 2(c). That further inhibits the decrease of the receiving buffer volume Br as shown in FIG. 2(c).

When t=13 and the transfer rate vr(13) recovers to ¼Mbps, the transfer rate vr(13)=vs/8 and hence the reproduction rate v₀(13)=vs/8. Accordingly, the receiving buffer volume Br does not vary until the transfer rate recovers further at t=15. When t=15 and the transfer rate vr(15) recovers, the receiving buffer volume Br gradually increases. Then, when t=15, Bu/2=4≧Br=4>Bu/4=2. When t=15, since the transfer rate vr(15)=0.5≧vs/4 and hence v₀(15+1)=vs/4 as show in FIG. 2(b), the control unit 140 controls the processor 130 to increase the reproduction speed to ¼ reproduction speed as shown in FIG. 2(c).

When t=21 and the transfer rate vr(21)=1≧vs/2=1 after further recovery of the transfer rate vr, Bu=8≧Br=6>Bu/2=4. When t=21, since the transfer rate vr(21)=1≧vs/2=1 and hence v₀(21+1)=vs/2 as show in FIG. 2(b), the control unit 140 controls the processor 130 to increase the reproduction speed to ½ reproduction speed as shown in FIG. 2(c).

When t=27 and the transfer rate vr(27)=2≧vs=2 after further recovery of the transfer rate vr, Br=8.5≧Bu=8. When t=27, the transfer rate vr(27)=vs=2 and hence v₀(27+1)=vs as show in FIG. 2(b). Accordingly, as shown in FIG. 2(c) the control unit 140 controls the processor 130 to increase the reproduction speed to the standard reproduction speed.

(Reproduction Operation of Reproducing Device)

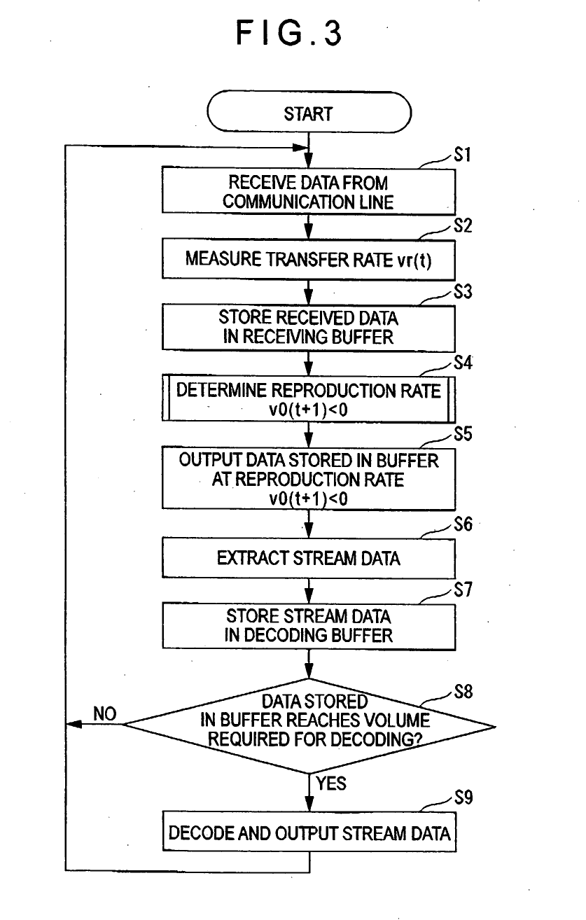

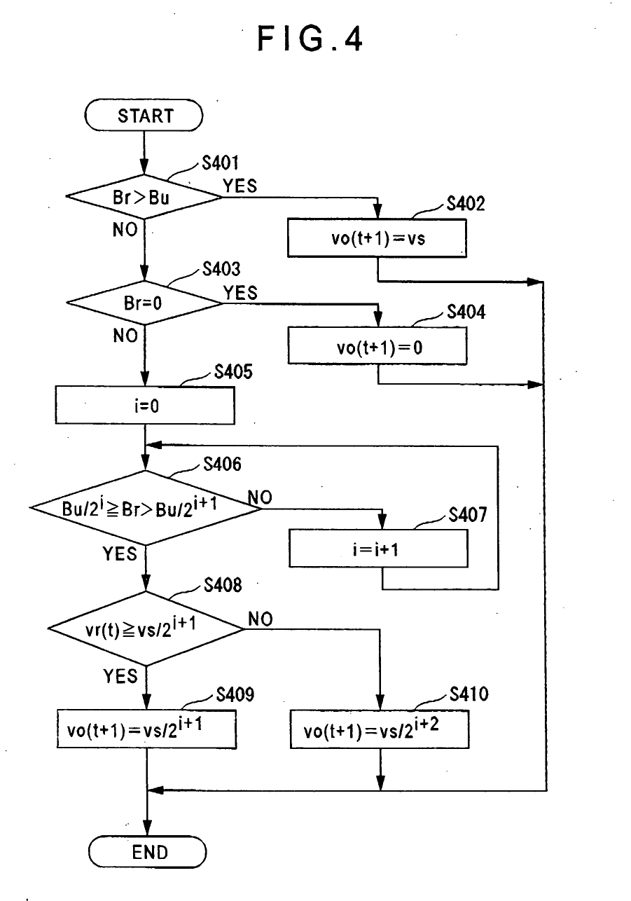

Next, the reproduction operation of the above reproducing device will be described with reference to the attached drawings FIG. 3 is a flowchart showing reproduction operation. FIG. 4 is a flowchart showing a processing operation to determine the reproduction rate for reproduction operation.

A user, for example, turns on power (not shown) to supply electric power to the reproducing device and performs a predetermined input operation with the input unit. The control unit 140 recognizes an operation signal corresponding to the input operation so that the network connector 110 selects a predetermined communication line to receive a desired picture data and audio data (step S1). For instance, the user selects a predetermined icon displayed on a screen of a web browser shown on the display device connected to the reproducing device using the input unit, so that the network connector 110 receives a data corresponding to the icon.

Then, the control unit 140 operates the communication line monitor 141 to measure the transfer rate vr(t) of the data received by the network connector 110 to output it to the reproduction speed controller 142 (step S2). The control unit 140 sequentially outputs the data received by the network connector 110 to the data receiving buffer 120 to be temporarily stored therein (step S3). Thereafter, the control unit 140 operates the reproduction speed controller 142 to perform a setting operation shown in FIG. 4 for computing and determining the reproduction rate v₀(t+1) of the data based on the transfer rate vr(t) measured by the communication line monitor 141 and the receiving buffer volume Br as described above (step S4).

In the setting operation of the reproduction rate v₀(t+1) of the data, as shown in FIG. 4, the reproduction speed controller 142 firstly determines whether it is true or false that the receiving buffer volume Br> the threshold Bu (step S401). If it is true that the receiving buffer volume Br> the threshold Bu, the reproduction speed controller 142 determines that enough data is stored in the data receiving buffer 120 and sets v₀(t+1) as vs to keep the standard reproduction speed (step S402). Thus the setting operation ends.

In contrast, if it is false that the receiving buffer volume Br> the threshold Bu, i.e., the reproduction speed controller 142 determines that the receiving buffer volume Br≦the threshold Bu, it determines whether it is true or false that the receiving buffer volume Br=0 (step S403). If it is true that the receiving buffer volume Br=0, i.e., the reproduction speed controller 142 determines that the data is not stored in the data receiving buffer 120, it sets v₀(t+1) as zero to stop the reproduction (step S404). Thus the setting operation ends. The following cases are examples in which the receiving buffer volume Br=0: the communication line is disconnected over a long time; although the communication line is connected, the transfer rate vr(t) remains zero over a long time and the volume of the data for reproduction is substantially zero; and a component such as the data receiving buffer 120 is damaged. In such cases, the reproduction is stopped since the communication is not in a proper condition, i.e., it is not ready for receiving data. Upon the reproduction stop, it is preferable to notify that the communication is in bad condition. For example, the control unit 140 may operate the display unit connected thereto to display a notification of a communication trouble, or may operate the audio unit to give an audio announcement of the communication trouble.

If at the step S403 it is false that the receiving buffer volume Br=0, i.e., the reproduction speed controller 142 determines that the data is stored in the data receiving buffer 120, it sets “i=0” in the conditional expression in the above Expression 1 (step S405). Thereafter, the reproduction speed controller 142 determines whether it is true or false that Bu/2ⁱ≧ the receiving buffer volume Br>Bu/2ⁱ⁺¹ (stop S406).

If the reproduction speed controller 142 determines it is false that Bu/2ⁱ≧Br>Bu/2ⁱ⁺¹, it adds “1” to “i”, i.e., sets “i=i +1” in the conditional expression in the above Expression 1 (step S407). Then it returns to the step S406 to repeat the operation. That is, the reproduction speed controller 142 determines in which range of the threshold Bu the receiving buffer volume Br falls.

If at the step S406 the reproduction speed controller 142 determines it is true that Bu/2ⁱ ≧Br>Bu/2ⁱ⁺¹, it determines whether it is true or false that vr(t)≧vs/2ⁱ⁺¹ based on the conditional expression in the above Expression 1 (step S408). Then, if the reproduction speed controller 142 determines it is true that vr(t)≧vs/2ⁱ⁺¹, it sets the reproduction rate v₀ as vs/2ⁱ⁺¹ after the following minimum unit of time, i.e., sets v₀(t+1)=vs/2ⁱ⁺¹ based on the conditional expression in the above Expression 1 (step S409). Thus the setting operation of the reproduction rate ends. If at the step S408 the reproduction speed controller 142 determines it is false that vr(t)≧vs/2ⁱ⁺¹, it sets v₀ as vs/2ⁱ⁺² after the following minimum unit of time, i.e., sets v₀(t+1) =vs/2ⁱ⁺² based on the conditional expression in the above Expression 1 (step S410). Thus the setting operation of the reproduction rate v₀ ends.

After the setting operation of the reproduction rate v₀(t+1) at the step S4 shown in the flowchart in FIG. 4 described above, the reproduction speed controller 142 operates the stream data extractor 131 of the processor 130 to output the data stored in the data receiving buffer 120 at the reproduction rate v₀(t+1) determined at the step S4 in the order of acquiring the data from the network connector 110 (step S5). Thereafter, the stream data extractor 131 extracts a series of contiguous data such as a stream picture data and a stream audio data out of the data with network packet structure sequentially output from the data receiving buffer 120 (step S6). The processor 130 sequentially outputs the stream data extracted by the stream data extractor 131 to the decoding buffer 132 to store it (step S7).

The reproduction speed controller 142 of the control unit 140 recognizes the data volume stored in the decoding buffer 132 and determines whether the data reaches the volume required for the decoding (step S8). If the reproduction speed controller 142 determines that the data volume in the decoding buffer 132 does not reach a predetermined volume, it returns to the step S1 to repeat the data acquiring operation. In contrast, if at the step S8 the reproduction speed controller 142 recognizes the data volume reaches the volume required for the decoding, it outputs the stream data stored in the decoding buffer 132 to the decoder 133 so that the decoder 133 decodes it. Then the data is output to the output unit as the reproduction data and reproduced. For example, a picture data is output to the display unit to be reproduced as a picture, or an audio data is output to the speaker of the audio unit to be reproduced as a sound (step S9). Then returning to the step S1, data is sequentially acquired.

When the reproduction speed controller 142 of the control unit 140 recognizes that the acquisition of the series of data is completed, the control unit 140 sets the reproduction rate v₀ as 2 Mbps as described above for example so that the data is reproduced at the standard reproduction speed irrespective of the remaining volume of the receiving buffer volume Br. The processor 130 sequentially processes and reproduces the data to end the data reproduction. The completion of the acquisition of the series of data may be recognized by any method including the use of an additional component.

[Advantages of First Embodiment]

In the above embodiment, as described earlier, under the control of the control unit 140, the data received by the network connector 110 over the network is sequentially stored in the data receiving buffer 120 temporarily, and sequentially processed by the processor 130 to be reproducible, i.e., output to the processor 130. At this time, if the receiving buffer volume Br becomes equal to or less than the threshold Bu, the control unit 140 controls the processor 130 to output the reproduction data at a slow reproduction rate so that the data is output and reproduced by the output unit at a reproduction speed slower than the standard reproduction speed. Therefore, for example, it is preventable that when the transfer rate vr (communication speed) decreases due to communication condition upon the acquisition of the data over the network, the receiving buffer volume Br becomes zero as shown by a dotted-line in FIG. 2(c) causing an underflow and consequently the decoding is suspended as shown by a dotted-line in FIG. 2(b) and the reproduction is stopped until the receiving buffer volume recovers to the certain volume as shown in FIG. 2(d). Accordingly, the user can recognize the continuously reproduced data without frequent reproduction stop even when the communication is not in a desirable condition, so that the user feels less discomfort during the use and its usability can be improved. That is effective especially when reproducing the data acquired over the network such as the Internet of which communication speed constantly fluctuates.

The control unit 140 controls the processor 130 to process the data so that the reproduction speed decreases as the receiving buffer volume Br decreases. Namely, the control unit 140 sets the speed for outputting the data to the processor 130. Therefore, the control responding to the remaining volume of the receiving buffer volume Br that varies depending on the acquiring state of the data from the network can be obtained, and thus the underflow can be surely prevented to enable a preferable data reproduction.

Since the reproduction rate v₀ is set to be lowered by a power-of-two, the data can be easily processed based on the receiving buffer volume Br with the use of the conditional expression. The control responding to the remaining volume of the receiving buffer volume Br that varies depending on the acquiring state of the data from the network can be easily performed with the use of the relatively simple conditional expression, thereby easily simplifying its configuration and improving its productivity.

When the control unit 140 controls the processor 130 to process the data to make the reproduction speed slower than the standard reproduction speed, the reproduction rate v₀ for outputting the data to the processor 130 from the data receiving buffer 120 is set. Therefore, the existing configuration of the processor 130 can be used as it is, and the control unit 140 for controlling the processing state of the processor 130 only requires an additional installation of the reproduction speed controller 142 for controlling the operation for outputting the data from the data receiving buffer 120. A continuous reproduction without the underflow can be thus easily obtained.

When the control unit 140 performs the control for setting the reproduction rate v₀, the reproduction rate v₀ is set based on the conditional expression shown in Expression 1. Since the reproduction rate v₀ is set by recognizing the receiving buffer volume Br classified based on the simple conditional expression, the computation for setting the reproduction rate v₀ can be easily performed and thus the setting of reproduction rate v₀ and the processing of the data can be smoothly performed, thereby achieving a smooth reproduction.

In the event of the occurrence of the underflow in which the receiving buffer volume Br becomes zero, the communication condition is determined as bad and the reproduction is stopped. With the reproduction stop, the user can be notified of the bad communication condition, the user may improve the communication condition or perform the operation for acquiring data again and reproducing it immediately after the improvement of the communication condition, thereby improving the usability. Upon this reproduction stop, it is notified by displaying it, so that the user can easily recognize the bad communication condition and quickly handle with it, thereby improving the usability.

When the completion of the acquisition of the series of data is recognized, the reproduction rate v₀ is so set to reproduce the data at the regular standard reproduction speed. That prevents the reproduction speed from gradually decreasing immediately before the end of the data, thereby obtaining a preferable data reproduction and improving the usability.

[Second Embodiment]

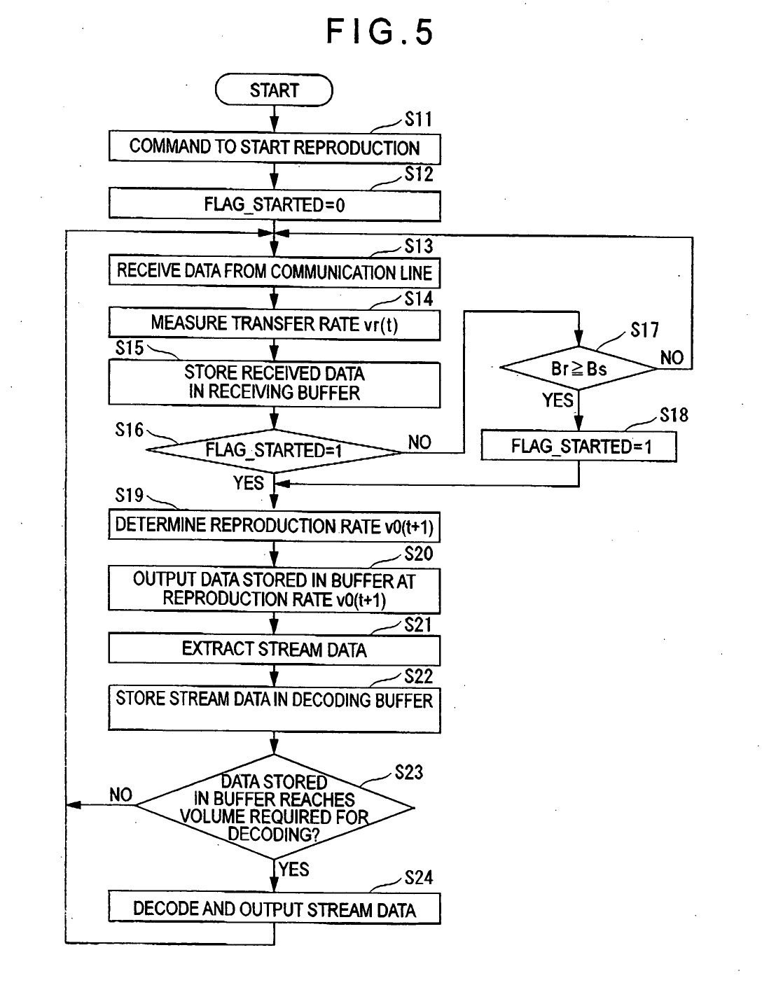

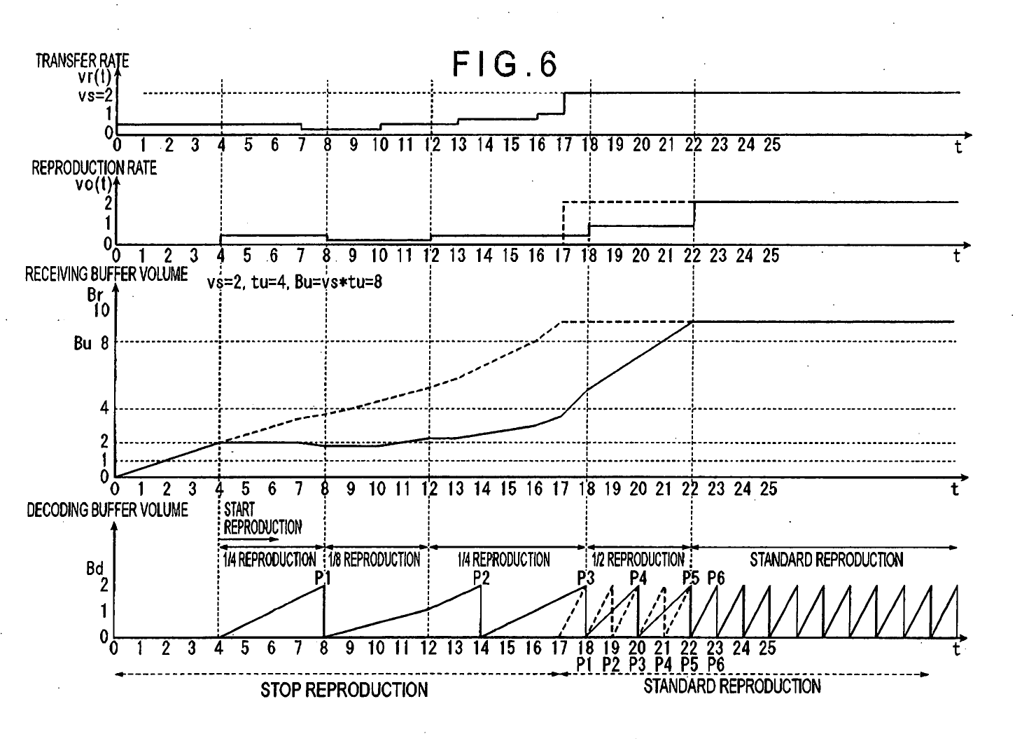

Next, a reproducing device according to a second embodiment of the present invention will be described with reference to FIGS. 5 and 6. FIG. 5 is a flowchart showing reproduction operation in the second embodiment. FIG. 6 is a graph showing control state of a control unit based on relationship between a transfer rate of receiving data and a receiving buffer volume in the first embodiment, in which (a) is a waveform chart showing the transfer rate, (b) is a waveform chart showing a reproduction rate, (c) is a waveform cart showing the receiving buffer volume, and (d) is a waveform chart showing a decoding buffer volume. As for the components identical with those in the first embodiment, same reference numerals are attached to omit the description thereof. The operation described in the second embodiment shown in FIGS. 5 and 6 is performed by the control unit 140 at the beginning of the data acquisition after the data reaches a predetermined receiving buffer volume Br in the reproduction operation in the first embodiment shown in FIGS. 1 to 4.

That is, when the control unit 140 recognizes an input operation by the user using the input unit (step S11), an initial value (zero) is set in initial state flag information (flag#started) which is initial state information stored, for example, in an internal memory as a storage of the control unit 140. In other words, zero indicating the beginning of the data acquisition by the network connector 110 for the data reproducing is set in the initial state flag information.

Then, in the same way as the above-mentioned first embodiment, the network connector 110 selects a predetermined communication line to receive a desired data (step S13). The communication line monitor 141 measures a transfer rate vr(t) to output it to the reproduction speed controller 142 (step S14). The control unit 140 sequentially outputs the data received by the network connector 110 to the data receiving buffer 120 to be temporarily stored therein (step S15). Then, the control unit 140 determines whether the initial state flag information is 1 (flag#started=1), i.e., the receiving buffer volume Br reaches at or above a predetermined threshold Bs and a processable state is set (step S16).

If at the step S16 the reproduction speed controller 142 determines that the initial state flag information is not 1, i.e., a receiving initial state in which the receiving buffer volume Br has never reached at or above the predetermined threshold Bs, the reproduction speed controller 142 determines whether the receiving buffer volume Br reaches at to or above the threshold Bs (Br≧Bs) (step S17). If at the step S17 the reproduction speed controller 142 determines that the receiving buffer volume Br does not reach at or above the threshold Bs, the reproduction speed controller 142 determines that the data required for the reproduction is not yet received and returns to the step S13 to repeat the data receiving operation.

In contrast, if at the step S17 the reproduction speed controller 142 determines that the receiving buffer volume Br reaches at or above the threshold Bs as shown in FIG. 6(c) (Bs=2 in FIG. 6(c)), the reproduction speed controller 142 determines that the state is ready for the data reproduction and sets 1 in the initial state flag information to make it the processable state (flag#started=1) (step S18).

Thereafter, the control unit 140 operates the reproduction speed controller 142 to perform a setting operation shown in FIG. 4 of the first embodiment for computing and determining the reproduction rate v₀(t+1) of the data based on the transfer rate vr(t) measured by the communication line monitor 141 and the receiving buffer volume Br as described above (step S19). The setting of the reproduction rate v₀ is computed based on the conditional expression of Expression 1 in the same way as the above-mentioned first embodiment. Specifically, as show in FIG. 6, since the receiving buffer volume Br reaches the threshold Bs=2, v₀(4+1)=vs/4 which is a condition for reproducing at 1/4 speed is set as shown in FIG. 6(d).

After the setting operation of the reproduction rate v₀(t+1) at the step 19, the reproduction speed controller 142 outputs the data stored in the data receiving buffer 120 to the stream data extractor 131 of the processor 130 in the order of acquiring the data from the network connector 110 at the reproduction rate v₀(t+1) (step S20). Then the stream data extractor 131 extracts a series of stream data out of the data sequentially acquired from the data receiving buffer 120 (step S21), and the stream data is sequentially output to the decoding buffer 132 (step S22).

With this output of the stream data to the processor 130, even if the volume drops below the predetermined threshold Bs=2 as show in FIG. 6(c), 1 is already set in the initial state flag information. Therefore, the control unit 140 does not stop the reproduction until the receiving buffer volume Br reaches at or above the threshold Bs=2 again. Instead, the control unit 140 sets v₀(8+1)=vs/8 so that the data is reproduced at a further slower speed, i.e., at ⅛ speed as shown in FIG. 6(d) and continues the reproduction.

The reproduction speed controller 142 of the control unit 140 recognizes the data volume stored in the decoding buffer 132 and determines whether the data reaches the volume required for the decoding (step S23). If the data does not reach the data volume required for the decoding, it returns the step 13 to repeat the data acquisition operation. In contrast, if at the step S23 the reproduction speed controller 142 recognizes the data reaches the volume required for the decoding, the reproduction speed controller 142 outputs the stream data stored in the decoding buffer 132 to the decoder 133 so that the decoder 133 decodes it and outputs it as the reproduction data to the output unit for the reproduction (step S24). Then returning to the step S13 again, the data is sequentially acquired.

When the reproduction speed controller 142 thus recognizes that the acquisition of the series of data is completed, the control unit 140 sets the reproduction rate v₀ as 2 Mbps as described above for example so that the data is reproduced at the standard reproduction speed irrespective of the remaining volume of the receiving buffer volume Br. The processor 130 sequentially processes and reproduces the data to end the data reproduction. In the second embodiment, the completion of acquisition of the series of data may be recognized by any method as in the first embodiment.

[Advantages of Second Embodiment]

As described above, at the beginning of the data acquisition by the network connector 110, until the data in the data receiving buffer 120 reaches the predetermined volume, i.e., until the receiving buffer volume Br reaches at or above the predetermined threshold Bs (e.g. Bs=2), the processor 130 stops processing the data For example, the data output from the data receiving buffer 120 to the processor 130 is stopped. Accordingly, with the operation as in the first embodiment, not only the advantages of the first embodiment, but also advantages including earlier start of reproduction, shorter waiting time, and better usability can be obtained comparing with the conventional art in which after the receiving buffer volume Br reaching the predetermined volume as shown by a dotted-line in FIG. 6(c) the data is reproduced at the standard reproduction speed as shown by a dotted-line in FIG. 6(d).

In the first embodiment, since the reproduction rate v₀ is set only based on the relationship with the threshold Bu and the operation for reproduction is started after the certain amount of the data is accumulated compared with the case in which the operation is started from the begging of the data reception, denominators of the reproduction rate v₀(t+1)=vs/2ⁱ⁺¹, v₀(t+1)=vs/2ⁱ⁺² are large at the beginning of the reproduction. Because of this, an image is displayed almost like a still image and the time for the receiving buffer volume Br to reach at or above the predetermined volume (e.g. greater than Bu=8) is required before the reproduction at the standard reproduction speed starts. In the second embodiment, these disadvantages are avoidable and the usability is improved.

Further, the operation for stopping output the data to the processor 130 until the receiving buffer volume Br reaches at the predetermined volume at the beginning of the data reception, and the operation for setting the reproduction rate v₀ after the receiving buffer volume Br reaches at the predetermined volume are classified by setting “0” or “1” in the initial state flag information. Accordingly, an appropriate reproduction state can be easily obtained with a simple configuration.

[Modification of Embodiments]

The present invention is by no means limited to the above-described embodiments, which may includes modification described below as long as the object of the present invention can be achieved.

Although the data for the reproduction is acquired over the Internet and the like and reproduced in the above embodiment, the data for reproduction may be acquired from satellites for satellite broadcast. Other than that, the data for. reproduction may be acquired or read from recording media including a CD (Compact Disk), a DVD (Digital Versatile Disc), a hard disk and a memory.

Although the data-such as stream picture data and stream audio data are extracted and reproduced in the described reproducing device, the data to be processed may be any information including as text data, programs and the like.

When the control unit 140 controls the operation of the processor 130 to reproduce the data at the speed slower than the standard reproduction speed, the setting of the reproduction rate v₀ for outputting the data from the data receiving buffer 120 to the processor 130 is changed. However, as long as reproduction speed can be changed finally, any method may be used. For example, the setting of extraction speed at which the processor 130 extracts the stream data, a speed to output from the decoding buffer to the decoder, a speed of decoding operation, a speed for reproducing as reproducing data or the like may be changed.

Although the storage according to the present invention is the data receiving buffer 120, the storage is not limited to a buffer. For example, a recording medium such as a hard disk and the like that temporarily store a data may be applicable as long as it can temporarily stores and sequentially output the data.

Although the processor according to the present invention is the processor 130, any component may be applicable as long as it can process the information. Similarly, the control unit according to the present embodiment is not limited to the control unit 140.

Although the threshold Bu is set so that the reproduction rate v₀ decreases step-by-step in response to the receiving buffer volume Br, the rate may decrease seamlessly. The value used for reducing the speed is not limited to a power-of-two, but may be set in any value. The control for reducing the speed is not limited to the conditional expression in Expression 1, but may be controlled by any method. The reproduction rate v₀ may be controlled by having a plurality of thresholds Bu.

The present invention may be in any form including a program readable by a computer as an arithmetic unit. In that case, the computer is operated to process the information stored in the recording medium loaded in the computer to make the information available for output. According to the invention, the arithmetic unit may be a single personal computer, a plurality of computers connected over a network, an element such as a microcomputer or a circuit substrate on which a plurality of electronic parts are mounted.

In the second embodiment, the initial state flag information is stored in the internal memory. However, any method may be used as long as it can identify the beginning of the information acquisition and the processable state in which the data in the data receiving buffer 120 has reached at or above the predetermined data volume, and the use of the internal memory is not necessarily required.

The present invention is not limited to the above specific embodiments and the modifications of the embodiments, but includes various modifications and improvements as long as the objects of the present invention can be attained.

[Advantages of Embodiments]

As described earlier, under the control of the control unit 140, the data received by the network connector 110 over the network is sequentially stored in the data receiving buffer 120 temporarily. If the receiving buffer volume Br becomes equal to or less than the predetemiined volume, the control unit 140 controls the processor 130 to output the reproduction data at a slow reproduction rate so that the data is output and reproduced by the output unit at a reproduction speed slower than the standard reproduction speed. Therefore, for example, it is preventable that when the data acquisition volume per a unit of time decreases during the data acquisition, an underflow is caused and consequently the reproduction is stopped. Accordingly, the reproducing data is continuously recognized without frequent reproduction stop, so that the user feels less discomfort during the use and the usability can be improved.

What is claimed is:

1. An information processor comprising:
an information acquiring unit that acquires information;
a storage that temporarily stores the information acquired by the information acquiring unit and sequentially outputs the information in the order of storing the information;
a processor that sequentially processes the information stored in the storage in an outputable manner; and
a control unit that controls the processor to sequentially process the information stored in the storage in the outputable manner, and controls the processor to process the information stored in the storage so that the information is output at a speed slower than a standard speed at which an output unit outputs the information when the volume of the information stored in the storage is equal to or less than a predetermined volume.

2. The information processor according to claim 1, wherein, when the information volume stored in the storage is equal to or less than the predetermined volume, the control unit controls the processor to process the information so that the speed for outputting the information decreases as the information volume decreases.

3. The information processor according to claim 2, wherein the control unit reduces the speed by a power-of-two when the information is output at the speed slower than the standard speed.

4. The information processor according to claim 1, wherein for controlling the processor to process the information so that the information is output at the speed slower than the standard speed for at which the output unit outputs the information, the control unit reduces a speed at which the storage outputs the information stored therein to the processor.

5. The information processor according to claim 4,
wherein, when the information volume stored in the storage is denoted by Br, a threshold as a standard for the control by the control unit is denoted by Bu, a speed at which the information acquiring unit acquires the information is denoted by vr, the speed at which the storage outputs the information to the processor is denoted by v₀, the standard speed at which the output unit outputs the information is denoted by vs, and a minimum unit of time is denoted by t,
the control unit sets the speed at which the storage outputs the information to the processor based on a conditional expression, which is, when Bu/2ⁱ≧Br>Bu/2ⁱ⁺¹, if vr(t)≧vs/2ⁱ⁺¹ is true then v₀(t+1)=vs/2ⁱ⁺², and if vr(t)≧vs/2ⁱ⁺¹ is false then v₀(t+1)=vs/2ⁱ⁺².

6. The information processor according to claim 1, wherein when the information acquiring unit starts acquiring the information, the control unit operates the processor to stop processing the information until a predetermined or more volume of information is stored.

7. The information processor according to claim 6, further comprising a state storage for storing initial state information,
wherein when the information acquiring unit starts acquiring the information, the control unit sets an indication of the beginning of acquisition in the initial state information, and when the control unit recognizes that the information in the storage reaches at or above the predetermined information volume, the control unit sets an indication of processable state in the initial state information and controls the processor to start processing the information.

8. The information processor according to claim 1, wherein the information acquiring unit acquires the information over a network.

9. An information processing method for acquiring information to sequentially process the information in an outputable manner, the method comprising the steps of:
acquiring information;
temporarily storing the acquired information; and
sequentially processing the information in the order of storing the information so that the information is output at a speed slower than a standard speed for outputting the information when the volume of the stored information is equal to or less than a predetermined volume.

10. An information processing program that executes an information processing method for acquiring information to sequentially process the information in an outputable manner by an arithmetic unit, the method comprising the steps of:
acquiring information;
temporarily storing the acquired information; and
sequentially processing the information in the order of storing the information so that the information is output at a speed slower than a standard speed for outputting the information when the volume of the stored information is equal to or less than a predetermined volume.

11. A recording medium storing an information processing program in a manner readable by an arithmetic unit,
wherein the information processing program executes an information processing method for acquiring information to sequentially process the information in an outputable manner by the arithmetic unit, the method comprising the steps of:
acquiring information;
temporarily storing the acquired information; and
sequentially processing the information in the order of storing the information so that the information is output at a speed slower than a standard speed for outputting the information when the volume of the stored information is equal to or less than a predetermined volume.

12. A reproducing device comprising:
the information processor according to claim 1; and
the output unit for outputting information processed by the information processor.
